(19) United States
(12) Patent Application Publication
(10) Pub. No.: US 2024/0412201 A1
(43) Pub. Date: Dec. 12, 2024

(54) WALLET TRANSACTION VALIDATION

(71) Applicant: AON RISK SERVICES, INC. OF MARYLAND, New York, NY (US)

(72) Inventor: Samuel Cameron Fleming, Spokane, WA (US)

(21) Appl. No.: 18/207,130

(22) Filed: Jun. 7, 2023

(51) Int. Cl. G06Q 20/36; G06Q 20/08; G06Q 20/38; G06Q 20/40

(52) U.S. Cl. CPC G06Q 20/3674; G06Q 20/0855; G06Q 20/389; G06Q 20/4014

(57) ABSTRACT

Systems and methods for wallet information and/or user information registration and verification are disclosed. Wallet information, such as a wallet identification (ID), and/or user information may be requested to be registered with an wallet ID registry. A record of the registration may be generated for the wallet ID registry such that the wallet ID registry may be searchable and/or offer functionality such as contractual obligations, insurance provision, and/or verification, among other benefits and functionalities.

### BACKGROUND

Digital service providers and marketplaces, such as non-fungible token (NFT) providers, are at a high degree of risk that a system compromise could lead to unverified transactions and/or fraud, which are largely uninsurable today. These service providers and marketplaces are often required to maintain privacy and limit monitoring of activity of private individuals. This runs contrary to the objectives of such companies as their business model relies on monetizing audience reach based on granular observations and understanding of individuals, which leads to premium advertising rates as it is highly targeted. Described herein are improvements in technology and solutions to technical problems that can be used to, among other things, assist in the protection of digital transactions.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for wallet information registration and verification system.

FIG. 2 illustrates a flow diagram of an example process for wallet information registration in accordance with a registration and verification system.

FIG. 3 illustrates an example user interface displaying wallet information registration functionality in accordance with a registration and verification system.

FIG. 4 illustrates an example user interface displaying token generation functionality in accordance with a registration and verification system.

FIG. 5 illustrates an example user interface displaying wallet information verification functionality in accordance with a registration and verification system.

FIG. 6 illustrates a flow diagram of another example process for wallet information registration in accordance with a registration and verification system.

FIG. 7 illustrates a flow diagram of another example process for wallet information registration in accordance with a registration and verification system.

FIG. 8 illustrates a flow diagram of an example process for training and utilizing one or more machine learning models to perform operations as described herein.

### DETAILED DESCRIPTION

Systems and methods for wallet identifier (ID) registration and verification are disclosed. Take, for example, a company or individual, described herein as an entity, that owns one or more assets (e.g., cryptocurrency, NFTs, etc.) and stores those assets in association with a wallet managed by a certified custodian. In some cases, a third-party marketplace may offer for sale digital assets (e.g., cryptocurrency, NFTs, etc.) to the entity via the entities wallet and the seller of the digital assets may desire to verify an authentication of the user and/or a wallet ID associated with the wallet prior to execution of the transaction. In these and other examples, a system that allows for the registration of such wallet IDs and/or other information associated with the user in a way that enables verification to the seller that purchaser is legitimate without disclosing unnecessary personal information associated with the purchaser would be beneficial to such entities.

The innovations described herein provide a wallet ID registration and authentication system that, among other things, enables the registration of information, documents and/or other property, provides user interfaces for registration and management of such information, documents and/or other property, enables verification of registration and/or analysis of information, documents and/or other property, assists in insurance provision, and utilizes data generated by and/or available to the system to increase functionality associated with the registered information, documents and/or other property. In some cases, services provided by the management system may be facilitated via an application programming interface (API) made available to users of the management system (e.g., purchasers, marketplace operators, creators, etc.). The proposed solution informs an abstraction between a wallet holder (e.g., user associated with a wallet) and the information requesting entity (e.g., marketplace, seller, advertising agency, etc.) such that personally identifiable information is not needed nor is it desired by the requesting entity. In effect, the wallet ID may represent a verifiable identity that includes a collection of attributes, wallet holdings, and behaviors that does not necessitate actual knowledge of individuals specific identity.

For example, a client-side device and/or system, herein described as an electronic device, may include an application that enables a user of the device and/or system to provide input data to the device. The input data may include a request to register a wallet ID with the system and may indicate information associated with a wallet, such as the wallet ID, as well as information associated with the user, such as an age of the user, tax information associated with the user, employment information associated with the user, residence information associated with the user, or citizenship information associated with the user, etc.

The client-side device and/or system may send, to a registry system, the input data and, in examples, request data indicating a request to register, in association with the user and/or a user profile, the wallet ID and/or the information associated with the user. The registry system may receive the input data and/or the request data and may store the wallet ID and the information associated with the user. In some examples, the registry system may generate a token that can be used for identity verification in response to receiving the input data and/or the request data. For example, a wallet holder may request generation and/or certification of such identity tokens by the registry system, which will in turn be assigned and/or issued to the wallet ID such that the user may demonstrate that certain requirements are met in the consumption of a given service. For example, the registry system may provide an allocation of a token (e.g., and NFT type token) that represent an identity parameter (e.g. “is over 21”). In some cases, the registry system may initiate a smart contract transaction effectively minting a request of a token with the wallet ID to which the identity parameter is intended to be assigned. Once the token is assigned to the wallet, registry system may act as a verification and/or a certifying authority. For example a service provider that desires to verify an age of a wallet holder, may query the registry system with a wallet ID. In some cases, the registry system may return the appropriate response if such a token exists for the wallet in question. In some examples, the tokens may be configured to be non-transferrable, as they will be valid only for the initial wallet to which it is assigned. In some examples, the query may be a blind query such that the service provide is not able to access any personal identifiable information associated with the user but, instead, only receives affirmative and/or disaffirmation responses.

In some cases, the registry system may send the input data and/or request data to a blockchain system managing one or more blockchains. The request data may indicate a request to register the wallet ID and/or identifying information associated with the user with the blockchain. The blockchain system may register the wallet ID and/or identifying information associated with the user described herein in association with a block of the blockchain. A token may be generated by the registry system that may represent the block in the blockchain. Additionally, or alternatively, a time value may be determined that indicates a time and/or day at which the wallet ID and/or identifying information associated with the user described herein was registered with the blockchain. The blockchain system may then send the token to the registry system and may additionally, or alternatively, send the token to the client-side device, particularly in instances where the request data to generate the token and/or to register the wallet ID was received from the client-side device.

The registry system may generate a record in the wallet ID registry. The record may include information associated with the wallet, the wallet ID, the user, and/or the token. For example, the record may associate the information together such that the wallet ID is stored in association with an age of the user, tax information associated with the user, employment information associated with the user, residence information associated with the user, or citizenship information associated with the user, a block number associated with the block of the blockchain that the token is registered with, a token ID, the time value, and/or one or more other types of data associated with the wallet and/or user, such as valuation, insurance policy information, versioning information, etc. The registry system, in examples, may generate confirmation data indicating that the record has been generated, and the confirmation data may be sent to the client-side device and/or system for display, e.g., via a user interface, or otherwise made available for programmatic consumption by an outside system.

In some examples, the token may be associated with one or more contractual obligations that may be designated and/or otherwise agreed to by the entity registering the wallet ID and/or information associated with the user. For example, contractual obligations may include assignment of rights, an attestation to accept legal liability, or an attestation to accept financial liability. In this way, the registry system may act as a central authority and/or a registry of rights and encumbrances established for digital assets in which participants (e.g., third-party marketplaces selling digital assets, minting digital assets, purchasing digital assets, purchasers of digital assets, sellers of digital assets, etc.) can reflect on registry status (e.g., contractual obligations) and impart governance rules on what are otherwise decentralized autonomous tokens.

In some examples, the registry system may receive a request to verify a wallet ID and/or obtain a transaction approval by receiving a wallet ID, a transaction amount, a product description, line items, purchase order (PO) number(s), and/or invoice number(s). For example, an entity that created an artifact and/or is associated (e.g., assigned) with a copyright of an artifact may offer for sale a number of NFTs associated with the copyright and/or artifact on a third-party marketplace. In some cases, the third-party marketplace may send a request to the registry system that a particular wallet ID associated with a wallet of a user attempting to make a purchase is authentic and/or is otherwise legitimate. In this case, the third-party marketplace may provide identifying data associated with the NFT to be purchased (e.g., block value information, information associated with the artifact, information associated with the copyright, a copyright registration number, a certificate of ownership registration number, etc.), a wallet ID and/or obtain a transaction approval by receiving a wallet ID, a transaction amount, a product description, line items, purchase order (PO) number(s), and/or invoice number(s). Once the registry system receives the information and the request to verify the wallet ID, the registry system may query the wallet ID registry to determine that the wallet to be used in the transaction is a legitimate and/or otherwise authentic wallet based on the wallet ID having previously been registered with the registry system. In some examples, the user associated with the wallet and/or the wallet ID may be sent a notification (e.g., via a text or mobile application) of the transaction and/or a request by the registry to approve the transaction. In this case the user may approve or deny the request. In this way, the registry system provides a second factor of authentication or protection should a wallet holders account be compromised. Once the wallet ID has been verified by the registry system and/or the registry system receives approval from the user, the registry system may send an indication to the third-party marketplace and/or a purchaser indicating a verification of the legitimacy of the wallet ID and/or the wallet to be used in the transaction.

In some examples, the registry system may receive a request to generate an insurance policy associated with a wallet and/or one or more digital assets associated with the wallet. For example, the registry system may be configured to assist in the application, underwriting, and provision of one or more insurance policies for a given wallet and/or one or more digital assets associated with the wallet. For example, once registered with the wallet ID registry, an option may be presented to gain insurance coverage on the wallet and/or one or more digital assets associated with the wallet. For example, a selectable portion of a user interface on the client-side device/system may provide the option to apply for an insurance policy. When selected, the user interface may display one or more dialog boxes and/or input fields configured to receive user input regarding application for an insurance policy. This information may include, for example, information relating to the applicant, information relating to the wallet and/or one or more digital assets associated with the wallet, a value of the wallet and/or one or more digital assets associated with the wallet (either determined from above or identified by the user), a desired policy period, desired policy limits and retention, an entity value, a date of creation of the wallet and/or one or more digital assets associated with the wallet, and/or a portion enabling uploading of supporting and/or requested documentation. In examples where supporting documentation is provided, the supporting documentation may be registered with the blockchain in the same or a similar manner as described above.

In some examples, the registry system may receive a request to generate an insurance claim associated with the wallet and/or one or more digital assets associated with the wallet. For example, the registry system may cause a user interface to display, via the client-side device/system, dialog boxes and/or input fields including text associated with submitting a claim for insurance coverage in association with an insurance policy for the wallet and/or one or more digital assets associated with the wallet. In these examples, given that an allegation of wallet and/or one or more digital assets associated with the wallet misappropriation, or other legal claim, may exist, one or more wizards may be initiated to assist in filing a claim for insurance coverage. Input data may be received representing responses to the dialog boxes, and based at least in part on receiving the input data, the input data may be formatted and/or sent to a remote system associated with an insurer indicating that a claim is to be filed and/or notifying the insurer of the potential misappropriation and/or other legal action.

In some examples, the registry system may receive a request from verified government agencies for the purpose of auditing transactions maintained within the registry system. For example, the register system may receive a request from a governmental agency which may include an indication of legal authority to identify an individual associated with a given wallet address and/or a wallet ID.

In examples, the functionality described herein may be provided, at least in part, via a user interface. The user interface may include one or more selectable portions that, when selected, may cause one or more processors to perform the operations described herein. For example, the user interface may include selectable portions indicating an option to register the wallet ID and/or information associated with the user in association with the wallet ID registry, enabling a user to select and/or identify the wallet ID and/or user information, enabling a user to view a record of the wallet ID registry, enabling a user to acquire and/or view information associated with an insurance policy associated with the wallet and/or digital assets associated with the wallet, enabling input of text for tag data generation, enabling searching capabilities of records associated with the wallet ID registry and/or records associated with the entity, and/or displaying links and/or associations between records. In some cases, the user interface may be made available to third-party entities and used to request a verification of a particular wallet ID associated with a wallet that is being used in a transaction. For example, the user interface may include one or more selectable portions enabling the third-party to provide the input data and/or request data discussed herein.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

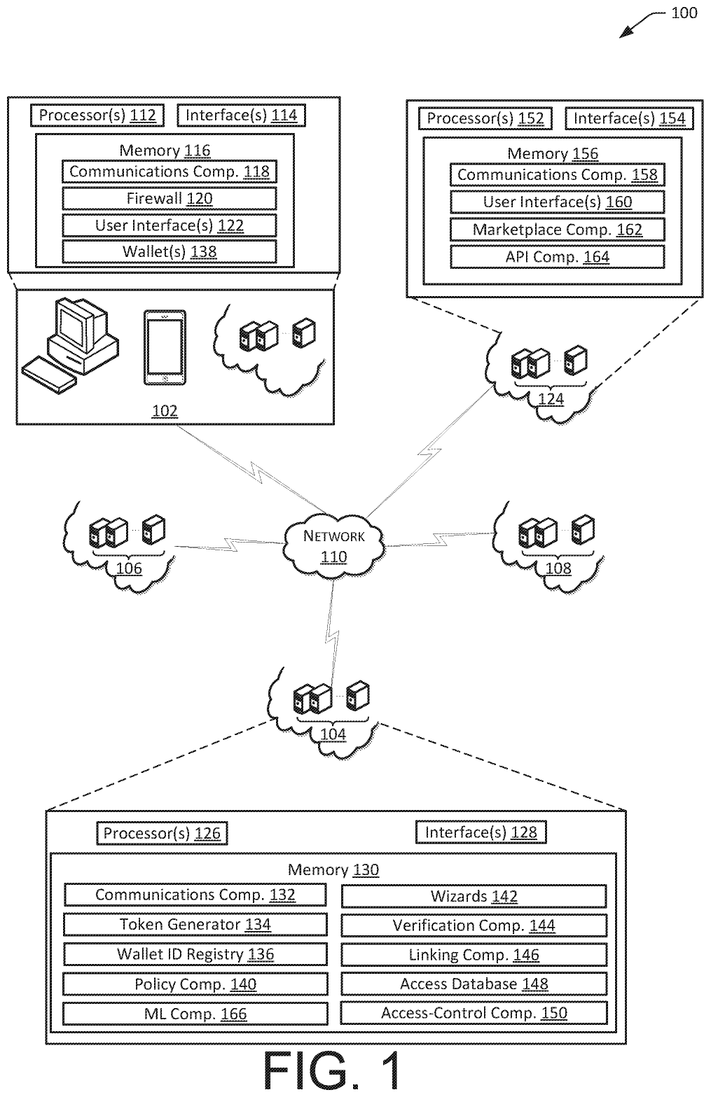

FIG. 1 illustrates a schematic diagram of an example architecture 100 for wallet ID registration and verification. The architecture 100 may include, for example, one or more client-side devices, also described herein as electronic devices 102, that allow clients to register and manage their wallet information (e.g., wallet ID and/or wallet address), information associated with the clients and/or users, and/or other intangible or digital assets. In some examples, the electronic devices 102 may be associated with a wallet and/or a user desiring to register wallet information to be stored by a registry system. The architecture 100 includes a registry system 104 associated with a wallet ID registry that is remote from, but in communication with, the client-side electronic devices. The architecture 100 further includes a distributed ledger system 106 that is remote from, but in communication with, the client-side devices 102 and the registry system 104. The distributed ledger system 106 utilizes blockchain technology to accept entries in a secure, verifiable manner, such as document obfuscation values associated with the wallet ID, the wallet, the token, and/or the user information being registered by the wallet ID registry. The architecture 100 also has an insurer system 108, which may also be described herein as a third remote system associated with an insurer. The insurer system 108 may utilize information from the registry system 104 and/or the distributed-ledger system 106 to, for example, issue insurance policies associated with the wallet ID, the wallet, the token, the user information, and/or other digital assets being registered by the wallet ID registry. The architecture 100 also has a third-party marketplace system 124 that is remote from, but in communication with, the client-side devices 102 and the registry system 104. The third-party marketplace system 124 may be used to perform transactions involving artifacts, copyrights associated with artifacts, and/or minted NFTs associated with artifacts. In some cases, the third-party marketplace 124 may desire to verify a wallet ID involved in a transaction via the registry system 104. Some or all of the devices and systems may be configured to communicate with each other via a network 110.

The electronic devices 102 may include components such as, for example, one or more processors 112, one or more network interfaces 114, and/or memory 116. The memory 116 may include components such as, for example, a communications component 118, a firewall 120, one or more user interfaces 122, and one or more wallets 138. As shown in FIG. 1, the electronic devices 102 may include, for example, a computing device, a mobile phone, a tablet, a laptop, and/or one or more servers. The components of the electronic device 102 will be described below by way of example. It should be understood that the example provided herein is illustrative, and should not be considered the exclusive example of the components of the electronic device 102.

By way of example, the user interface(s) 122 may include a selectable portion that, when selected, may enable identification of a wallet ID associated with the wallet 138, user information, and/or other information associated with the wallet 138 (e.g., digital assets stored on the wallet 138, wallet address associated with the wallet 138, etc.). For example, the selectable portion and/or another portion of the user interface 122 may include text requesting that a user of the user interface 122 select the selectable portion to identify information to be registered in association with the wallet ID registry. The user may provide input to the electronic device 102 indicating the information to be registered (e.g., wallet ID, wallet address, and/or user information such as, but limited to, an age of the user, tax information associated with the user, employment information associated with the user, residence information associated with the user, and/or citizenship information associated with the user).

The communications component 118 may be configured to enable communications between the electronic device 102 and the other components of the architecture 100, such as the registry system 104, the distributed-ledger system 106, the insurer system 108, and/or the third-party marketplace system 124. The communications component 118 may further generate data to be communicated and/or may format already-generated data for transfer to one or more of the remote systems. The communications component 118 may also be configured to receive data from one or more of the remote systems.

The firewall 120 may be configured to receive data from the communications component 118 and/or from one or more other components of the electronic device 102. The firewall 120 may be described as a network security system that may monitor and/or control incoming and outgoing data based on security rules. The security rules may indicate that the electronic device 102 is configured to send certain data to the registry system 104, and/or the distributed-ledger system 106, the insurer system 108, and/or the third-party marketplace system 124. The security rules may also indicate that the electronic device 102 is configured to receive certain data from the registry system 104, the distributed-ledger system 106, the insurer system 108, and/or the third-party marketplace system 124. The firewall 120 may be utilized to control the distribution of sensitive information, particularly when the architecture 100 is being utilized to register confidential documents with the wallet ID registry.

The wallet 138 may be configured to store one or more digital assets (e.g., cryptocurrency, NFTs, etc.) owned by the user of the electronic device 102 and/or the wallet 138. The wallet 138 may be used by the user to participate in a transaction, such as a transaction with the third-party marketplace system 124. In some examples, the wallet 138 may be associated with a unique wallet ID and/or wallet address that may be provided to the registry system 104 to be registered in a wallet ID registry.

The registry system 104 may include components such as, for example, one or more processors 126, one or more network interfaces 128, and memory 130. The memory 130 may include components such as, for example, a communications component 132, a token generator 134, wallet ID registry 136, a policy component 140, one or more wizards 142, a verification component 144, a linking component 146, an access database 148, an access-control component 150, and/or a machine learning component 166. The components of the registry system 104 will be described below by way of continued example. It should be understood that the example provided herein is illustrative, and should not be considered the exclusive example of the components of the registry system 104. It should be understood that when a system and/or device is described herein as a “remote system” and/or a “remote device,” the system and/or device may be situated in a location that differs from, for example, the electronic device 102.

The communications component 132 may be configured to enable communications between the registry system 104 and the other components of the architecture 100, such as the electronic device 102, the distributed-ledger system 106, the insurer system 108, and/or the third-party marketplace system 124. The communications component 132 may further generate data to be communicated and/or may format already-generated data for transfer to other components of the architecture 100. The communications component 132 may also be configured to receive data from one or more of the other remote systems and/or the electronic device 102.

The token generator 134 of the registry system 104 may generate a token that can be used for identity verification in response to receiving the input data and/or the request data. For example, a user associated with the electronic device 102 and/or the wallet 138 may request generation and/or certification of such identity tokens by the registry system 104, which will in turn be assigned and/or issued to the wallet ID such that the user may demonstrate that certain requirements are met in the consumption of a given service. For example, the registry system 104 may provide an allocation of a token (e.g., and NFT type token), via the token generator 134, that represent an identity parameter (e.g. “is over 21”). In some cases, the registry system 104 may initiate a smart contract transaction effectively minting a request of a token with the wallet ID to which the identity parameter is intended to be assigned. Once the token is assigned to the wallet 138, the registry system 104 may act as a verification and/or a certifying authority. For example a service provider (e.g., third-party marketplace 124) that desires to verify an age of the user associated with the wallet 138, may query the registry system 104 with a wallet ID associated with the wallet 138. In some examples, the query may be a blind query such that the service provide is not able to access any personal identifiable information associated with the user but, instead, only receives affirmative and/or disaffirmation responses. In some cases, the registry system 104 may return the appropriate response if such a token exists for the wallet in question. In some examples, the tokens may be configured to be non-transferrable, as they will be valid only for the initial wallet to which it is assigned. In some examples, the token may be associated with one or more contractual obligations that may be designated and/or otherwise agreed to by the entity registering the wallet ID and/or information associated with the user. For example, contractual obligations may include assignment of rights, an attestation to accept legal liability, or an attestation to accept financial liability. In this way, the registry system 104 may act as a central authority and/or a registry of rights and encumbrances established for digital assets in which participants (e.g., third-party marketplaces selling digital assets, minting digital assets, purchasing digital assets, purchasers of digital assets, sellers of digital assets, etc.) can reflect on registry status (e.g., contractual obligations) and impart governance rules on what are otherwise decentralized autonomous tokens.

As used herein, a blockchain is a list and/or ledger of records, also described as blocks, that are linked using cryptography. A block in the blockchain contains a cryptographic hash of the previous block, a time value or timestamp, and, in examples, transaction data. The blockchain may be utilized to record transactions between two entities and/or systems. In these examples, the blockchain may be utilized to record the transaction of registering the wallet ID and/or identifying information associated with the user in a wallet ID registry between the electronic device 102 and the registry system 104. As described in more detail elsewhere herein, the blockchain may also be utilized to register digital asset documentation, insurance policy documents, and/or other information associated with the wallet ID registry. The blockchain may be managed by a peer-to-peer network collectively adhering to a protocol for inter-node communication and validating new blocks. Once recorded in a block, the data cannot be altered without alteration of all subsequent blocks, which would require a majority of the network to agree upon.

In examples, multiple blockchain systems may be utilized to register the transaction between the registry system 104 and the electronic device 102. For example, the wallet information (e.g., wallet ID) and/or identifying information associated with the user may be sent to multiple blockchain systems, and each blockchain system may return a cryptographic document obfuscation value corresponding to a block in their respective blockchains. As described more fully below, the record indicating registration of the wallet information and/or identifying information associated with the user with the wallet ID registry 136 may include the multiple cryptographic document obfuscation values and/or other information associated with registration of blocks in the multiple blockchains.

The wallet ID registry 136 may store information associated with a wallets, such as the wallet 138 and/or information associated with users. For example, the electronic device 102 may send to the registry system 104, input data and, in examples, request data indicating a request to register, in association with the user and/or a user profile, the wallet ID and/or the information associated with the user. The registry system 104 may receive the input data and/or the request data and may store the wallet ID and the information associated with the user via the wallet ID registry 136. In some cases, the wallet ID registry 136 may generate and store a record including information associated with the wallet, the wallet ID, the user, and/or the token. For example, the record may associate the information together such that the wallet ID is stored in association with an age of the user, tax information associated with the user, employment information associated with the user, residence information associated with the user, or citizenship information associated with the user, a block number associated with the block of the blockchain that the token is registered with, a token ID, the time value, and/or one or more other types of data associated with the wallet and/or user, such as valuation, insurance policy information, versioning information, etc. The wallet ID registry 136, in examples, may generate confirmation data indicating that the record has been generated, and the confirmation data may be sent to the electronic device 102 for display, e.g., via a user interface, or otherwise made available for programmatic consumption by an outside system. In examples, auditing of access and/or edit history associated with records may be performed such that if a user interacts with the record, data indicating interaction of that user with the information associated with the record may be surfaced and/or reported. In addition, audit logs and/or data may be registered to the distributed-ledger to verify when auditing was performed.

In examples, the wallet ID registry 136 may be searchable. For example, an interface may be generated and configured to allow access to at least a portion of the wallet ID registry 136 via the electronic device 102, the third-party marketplace system 124, and/or a remote docketing system associated with other digital assets. Access information, as described more fully herein with respect to the access-control component 150, may be sent for accessing the interface. The registry system 104 may receive, such as from the electronic device 102, the third-party marketplace system 124, and/or a remote docketing system, a request to perform a search of the wallet ID registry 136. In these examples, the request may include text data to be utilized to search the wallet ID registry 136. The text data may be utilized to identify results of the search and results data representing the results may be sent to the remote docketing system and/or the electronic device 102.

The policy component 140 may be configured to assist in the application, underwriting, and provision of one or more insurance policies for a given a wallet and/or one or more digital assets associated with the wallet. For example, once registered with the wallet ID registry 136, an option may be presented to gain insurance coverage on the wallet and/or one or more digital assets associated with the wallet. For example, a selectable portion of the user interface 122 may provide the option to apply for an insurance policy. When selected, the user interface 122 may display one or more dialog boxes and/or input fields configured to receive user input regarding application for an insurance policy. This information may include, for example, information relating to the wallet and/or one or more digital assets associated with the wallet, a value of the wallet and/or one or more digital assets associated with the wallet (either determined from above or identified by the user), a desired policy period, desired policy limits and retention, an entity value, a date of creation of the wallet and/or one or more digital assets associated with the wallet, and/or a portion enabling uploading of supporting and/or requested documentation. In examples where supporting documentation is provided, the supporting documentation may be registered with the blockchain in the same or a similar manner as described above.

The policy component 140, and/or the communications component 132, may be configured to receive input data corresponding to the user input and may send the input data to the insurer system 108, which is associated with an insurer. The insurer system 108 may process the input data and, in examples, underwrite and/or issue a policy insuring the wallet and/or digital assets associated with the wallet, for example, misappropriation. In these examples, confirmation data indicating that the policy has been issued and information associated with the policy may be received from the insurer system 108. This information may be incorporated into the record associated with the wallet and/or digital assets associated with the wallet and may be displayed via the user interface 122, in examples. Some nonlimiting examples of information associated with the insurance policy may include a policy type, a limit of liability, a retention value, a policy premium, a policy form, a policy number, a policy period, a sub-limit of liability, and/or a valuation the wallet and/or digital assets associated with the wallet. Additionally, or alternatively, the information may include a payout value or values associated with amounts of money to be paid to the entity associated with the wallet and/or digital assets associated with the wallet upon the occurrence of different classes of events including different levels of unauthorized access or use. In these examples, the policy component 140 may receive noncompliance data indicating that the entity has not complied with a condition of the insurance policy and may cause display of updated insurance-policy information including an indicating that curative action is required and/or an updated payout value. In these examples, the updated payout value may be less than the original payout value. As the condition is met, the payout value may be updated to reflect compliance with the condition of the insurance policy.

In examples, one or more smart contracts may be utilized in association with the policy component 140. For example, the insurance policy may be associated with a given wallet and/or digital assets associated with the wallet using a smart contract associated with the blockchain. A smart contract, as described herein, may be a computer protocol to digitally facilitate, verify, and/or enforce the negotiation and/or performance of a contract. Transactions involving smart contracts may be trackable and irreversible. The smart contracts may utilize, for example, Byzantine fault tolerant algorithms that may allow digital security through decentralization of the contract. The smart contracts may be initiated, hosted, and/or implemented, at least in part, by the distributed-ledger system 106 associated with the blockchain. In these examples, the smart contract may indicate a condition for validating an insurance policy, such as management's continued investment in threshold level of digital and/or physical security, and validation data may be received that indicates the condition has been met. In these examples, the validation data may be sent to the distributed-ledger system 106, which may cause the smart contract to validate the insurance policy.

The wizards 142 as described herein may be a set of dialog boxes and/or input fields configured to be displayed, such as via the electronic device 102. For example, a wizard 142 may be utilized to receive user input for wallet ID registration, verification, determination, and/or support. Additionally, or alternatively, a wizard 142 may be utilized to receive user input for insurance policy application, underwriting, and provision. In examples where a wizard 142 is utilized for insurance policy provision, the wizard 142 and/or information associated with the wizard 142 may be provided by and/or may be specific to a given insurer. Additionally, or alternatively, a wizard 142 may be utilized to submit a notice of a potential misappropriation event and/or an insurance claim, as described more fully herein.

The verification component 144 may be configured to verify that information involved in a transaction has been registered with the wallet ID registry 136. For example, once registered, the verification component 144 may be utilized to determine if and/or verify that other information, such as a wallet ID involved in a transaction, matches or is similar to the information included in the wallet ID registry. The registry system 104 may receive a request to verify a wallet ID and/or obtain a transaction approval by receiving a wallet ID, a transaction amount, a product description, line items, purchase order (PO) number(s), and/or invoice number(s). For example, an entity that created an artifact and/or is associated (e.g., assigned) with a copyright of an artifact may offer for sale a number of NFTs associated with the copyright and/or artifact on the third-party marketplace system 124. In some cases, the third-party marketplace system 124 may send a request to the registry system 104 that a particular wallet ID associated with a wallet of a user attempting to make a purchase is authentic and/or is otherwise legitimate. In this case, the third-party marketplace system 124 may provide identifying data associated with the NFT to be purchased (e.g., block value information, information associated with the artifact, information associated with the copyright, a copyright registration number, a certificate of ownership registration number, etc.), a wallet ID and/or obtain a transaction approval by receiving a wallet ID, a transaction amount, a product description, line items, purchase order (PO) number(s), and/or invoice number(s). Once the verification component 144 receives the information and the request to verify the wallet ID, the verification component 144 may query the wallet ID registry 136 to determine that the wallet to be used in the transaction is a legitimate and/or otherwise authentic wallet based on the wallet ID having previously been registered with the wallet ID registry 136. In some examples, the user associated with the wallet and/or the wallet ID may be sent a notification (e.g., via a text or mobile application) of the transaction and/or a request by the verification component 144 to approve the transaction. In this case the user may approve or deny the request. In this way, the registry system 104 provides a second factor of authentication or protection should a wallet holders account be compromised. Once the wallet ID has been verified by the verification component 144 and/or the verification component 144 receives approval from the user, the registry system 104 may send an indication to the third-party marketplace system 124 and/or a purchaser indicating a verification of the legitimacy of the wallet ID and/or the wallet to be used in the transaction.

The linking component 146 may be configured to associate one record with one or more other records in the wallet ID registry 136. For example, when records are determined to be different versions of the same document and/or when records are associated with the same entity identifier, the linking component 146 may be utilized to generate an association between those records. Generating the association may include storing data indicating that the records are associated. Generating the association may also, or alternatively, include generating a link or other similar functionality that may be displayed along with a record via the user interface(s) 122. For example, the link may correspond to a selectable portion of the user interface(s) 122 that, when selected, may cause the linked record and/or a portion thereof to be displayed.

The access database component 148 may be configured to store data indicating details of access to one or more of the record associated with the wallet ID registry 136. For example, access-control data may be stored in association with the registry system 104. The access-control data may indicate who is authorized to view a given record and/or given information associated with a record. In these examples, the access-control component 150 may be configured to require a user, in order to access a record, to authenticate the user's identity, such as by inputting a username and/or password, for example. As such, the registry system 104 may generate an access log that may indicate user identifiers for users that accessed a given record, a time value associated with access of the record, and/or what information was displayed and/or manipulated by the user. The access log may be utilized by the registry system 104 to assist in maintaining confidentiality and/or security of the wallet information and/or the user information. For example, alerts may be generated and/or sent when a record is accessed and/or when unusual activity is detected.

The third-party marketplace system 124 may include components such as, for example, one or more processors 152, one or more network interfaces 154, and/or memory 156. The memory 156 may include components such as, for example, a communications component 158, one or more user interfaces 160 a marketplace component 162, and/or an application programming interface (API) component 164. The components of the third-party marketplace system 124 will be described below by way of example. It should be understood that the example provided herein is illustrative, and should not be considered the exclusive example of the components of the third-party marketplace system 124. The communications component 158 and the user interfaces 160 may include the same or similar functionality as the communications component 118 and the user interfaces 122 of the electronic device 102 and be used to communicate with and interface with the electronic device 102, the registry system 104, the distributed-ledger system 106, and/or the insurer system 108.

The marketplace component 162 may be configured to enable entities to sell and/or purchase items associated with artifacts and/or copyrights. For example, the items for sale on the third-party marketplace system 124 may include artifacts that have copyrights, NFTs associated with artifacts, and/or NFTs associated with copyrights. The third-party marketplace system 124 may verify the authenticity of wallets used in transaction by sending a verification request and/or wallet information (e.g., wallet IDs) to the registry system 104.

The API component 164 may be configured to enable users of the third-party marketplace system 124 to interact with services provided by the registry system 104. For example, a purchasing entity accessing the marketplace component 162 to purchase an item, such as, an NFT associated with an artifact and/or copyright, may desire obtain insurance on the item, and/or request an insurance claim on the item. The third-party marketplace system 124 may present the API component 164 such that the purchasing entity may interact with the registry system 104 in order to verify, insure, and/or issue an insurance claim on the item.

As shown in FIG. 1, several of the components of the registry system 104, the distributed-ledger system 106, the insurer system 108, and/or the third-party marketplace system 124 and the associated functionality of those components as described herein may be performed by one or more of the other remote systems and/or by the electronic device 102. Additionally, or alternatively, some or all of the components and/or functionalities associated with the electronic device 102 may be performed by the registry system 104, the distributed-ledger system 106, the insurer system 108, and/or the third-party marketplace system 124.

It should be noted that the exchange of data and/or information as described herein may be performed only in situations where a user has provided consent for the exchange of such information. For example, a user may be provided with the opportunity to opt in and/or opt out of data exchanges between devices and/or with the remote systems and/or for performance of the functionalities described herein. Additionally, when one of the devices is associated with a first user account and another of the devices is associated with a second user account, user consent may be obtained before performing some, any, or all of the operations and/or processes described herein.

As used herein, a processor, such as processor(s) 112, 152, and/or 126, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 112, 152, and/or 126 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112, 152, and/or 126 may possess its own local memory, which also may store program components, program data, and/or one or more operating systems.

The memory 116, 156, and/or 130 may include volatile and nonvolatile memory, removable and non-removable media implemented in any method or technology for storage of information, such as computer-readable instructions, data structures, program component, or other data. Such memory 116, 156, and/or 130 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 116, 156, and/or 130 may be implemented as computer-readable storage media (“CRSM”), which may be any available physical media accessible by the processor(s) 112, 152, and/or 126 to execute instructions stored on the memory 116, 156, and/or 130. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 116, 156, and/or 130, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon.com Inc. of Seattle, Washington, USA; the Windows operating system from Microsoft Corporation of Redmond, Washington, USA; LynxOS as promulgated by Lynx Software Technologies, Inc. of San Jose, California; Operating System Embedded (Enea OSE) as promulgated by ENEA AB of Sweden; and so forth.

The network interface(s) 114, 154 and/or 128 may enable messages between the components and/or devices shown in architecture 100 and/or with one or more other remote systems, as well as other networked devices. Such network interface(s) 114, 154 and/or 128 may include one or more network interface controllers (NICs) or other types of transceiver devices to send and receive messages over the network 110.

For instance, each of the network interface(s) 114, 154 and/or 128 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 114 and/or 128 may include a wide area network (WAN) component to enable message over a wide area network.

In some instances, the registry system 104 may be local to an environment associated the electronic device 102. For instance, the registry system 104 may be located within the electronic device 102. In some instances, some or all of the functionality of the registry system 104 may be performed by the electronic device 102. Also, while various components of the registry system 104 have been labeled and named in this disclosure and each component has been described as being configured to cause the processor(s) to perform certain operations, it should be understood that the described operations may be performed by some or all of the components and/or other components not specifically illustrated.

In some cases, any or all of the steps performed by the registry system 104 and the associated components may be done so using one or more machine learning models and/or by training one or more machine learning models via a machine learning component 166. For example the communications component 132, the token generator 134, the wallet ID registry 136, the policy component 140, the one or more wizards 142, the verification component 144, the linking component 146, the access database 148, and/or the access-control component 150 may utilize one or more machine learning models and/or by train one or more machine learning models to perform the respective operations discussed herein. As described herein, machine learned models may be generated using various machine learning techniques. For example, the models may be generated using one or more neural network(s). A neural network may be a biologically inspired algorithm or technique which passes input data through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from data. In some cases, the neural network may be a trained network architecture that is end-to-end. In one example, the machine learned models may include segmenting and/or classifying extracted deep convolutional features of data into semantic data. In some cases, appropriate truth outputs of the model in the form of semantic per-pixel classifications.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, ResNeXt101, VGG, DenseNet, PointNet, CenterNet and the like. In some cases, the system may also apply Gaussian blurs, Bayes Functions, color analyzing or processing techniques and/or a combination thereof.

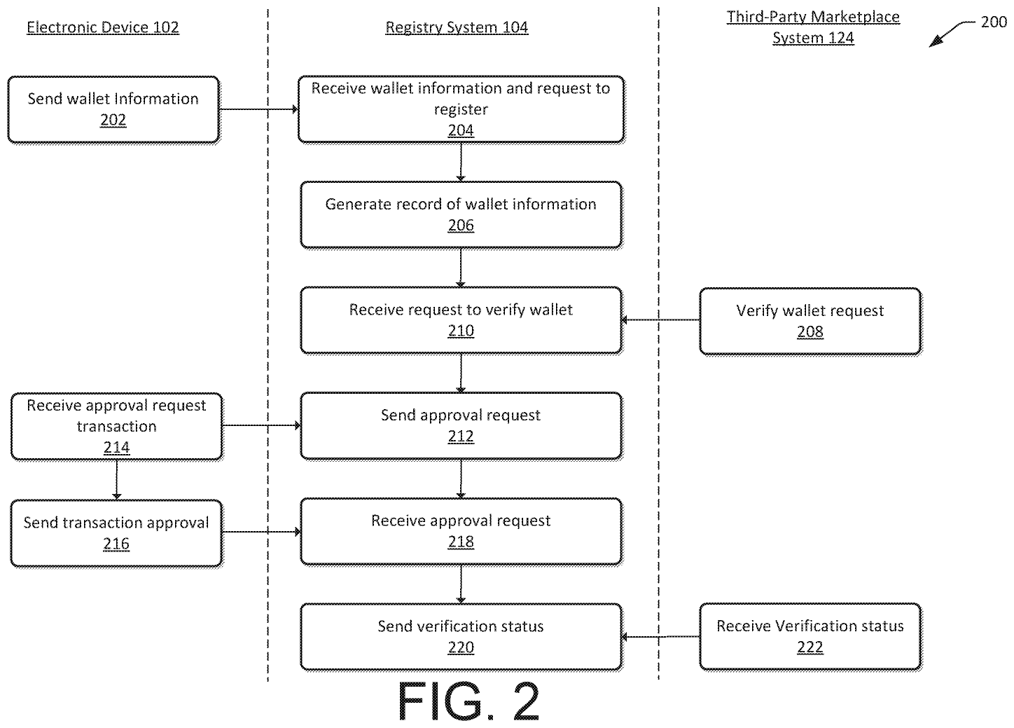

FIG. 2 illustrates a process for wallet information registration and verification. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIG. 2, although the processes may be implemented in a wide variety of other environments, architectures and systems.

FIG. 2 illustrates a flow diagram of an example process 200 for wallet information registration and verification in accordance with a registry system. The order in which the operations or steps are described is not intended to be construed as a limitation, and any number of the described operations may be combined in any order and/or in parallel to implement process 200. The operations described with respect to the process 200 are described as being performed by the electronic device, and/or the registry system associated with the wallet ID registry, and/or a third-party marketplace system. However, it should be understood that some or all of these operations may be performed by some or all of components, devices, and/or systems described herein.

At block 202, the process 200 may include the electronic device 102(a) sending wallet information and a request to register to the registry system 104. At block 204 the process 204 may include the registry system 104 receiving the wallet information and the request to register. By way of example, a client-side device and/or system, herein described as an electronic device, may include an application that enables a user of the device and/or system to provide input data to the device. The input data may include a request to register a wallet ID with the system and may indicate information associated with a wallet, such as the wallet ID, as well as information associated with the user, such as an age of the user, tax information associated with the user, employment information associated with the user, residence information associated with the user, or citizenship information associated with the user, etc. The client-side device and/or system may send, to a registry system, the input data and, in examples, request data indicating a request to register, in association with the user and/or a user profile, the wallet ID and/or the information associated with the user.

At block 206, the process 200 may include the registry system generating a record of the wallet information. For example, the registry system 104 may store the wallet information in a wallet ID registry. In some examples, the registry system may generate a token that can be used for identity verification in response to receiving the input data and/or the request data. For example, a wallet holder may request generation and/or certification of such identity tokens by the registry system, which will in turn be assigned and/or issued to the wallet ID such that the user may demonstrate that certain requirements are met in the consumption of a given service. For example, the registry system may provide an allocation of a token (e.g., and NFT type token) that represent an identity parameter (e.g. “is over 21”). In some cases, the registry system may initiate a smart contract transaction effectively minting a request of a token with the wallet ID to which the identity parameter is intended to be assigned. Once the token is assigned to the wallet, registry system may act as a verification and/or a certifying authority. For example a service provider that desires to verify an age of a wallet holder, may query the registry system with a wallet ID. In some cases, the registry system may return the appropriate response if such a token exists for the wallet in question. In some examples, the tokens may be configured to be non-transferrable, as they will be valid only for the initial wallet to which it is assigned. In some examples, the query may be a blind query such that the service provide is not able to access any personal identifiable information associated with the user but, instead, only receives affirmative and/or disaffirmation responses. In some cases, the registry system may send the input data and/or request data to a blockchain system managing one or more blockchains. The request data may indicate a request to register the wallet ID and/or identifying information associated with the user with the blockchain. The blockchain system may register the wallet ID and/or identifying information associated with the user described herein in association with a block of the blockchain. A token may be generated by the registry system that may represent the block in the blockchain. Additionally, or alternatively, a time value may be determined that indicates a time and/or day at which the wallet ID and/or identifying information associated with the user described herein was registered with the blockchain. The blockchain system may then send the token to the registry system and may additionally, or alternatively, send the token to the client-side device, particularly in instances where the request data to generate the token and/or to register the wallet ID was received from the client-side device.

In some cases, the registry system may generate a record in the wallet ID registry. The record may include information associated with the wallet, the wallet ID, the user, and/or the token. For example, the record may associate the information together such that the wallet ID is stored in association with an age of the user, tax information associated with the user, employment information associated with the user, residence information associated with the user, or citizenship information associated with the user, a block number associated with the block of the blockchain that the token is registered with, a token ID, the time value, and/or one or more other types of data associated with the wallet and/or user, such as valuation, insurance policy information, versioning information, etc. The registry system, in examples, may generate confirmation data indicating that the record has been generated, and the confirmation data may be sent to the client-side device and/or system for display, e.g., via a user interface, or otherwise made available for programmatic consumption by an outside system.

At block 208, the process 200 may include the third-party marketplace system 124 sending a verify wallet request and at block 210 of the process 200 may include the registry system 104 receiving the request to verify the wallet. For example, the registry system may receive a request to verify a wallet ID and/or obtain a transaction approval by receiving a wallet ID, a transaction amount, a product description, line items, purchase order (PO) number(s), and/or invoice number(s). For example, an entity that created an artifact and/or is associated (e.g., assigned) with a copyright of an artifact may offer for sale a number of NFTs associated with the copyright and/or artifact on a third-party marketplace. In some cases, the third-party marketplace may send a request to the registry system that a particular wallet ID associated with a wallet of a user attempting to make a purchase is authentic and/or is otherwise legitimate. In this case, the third-party marketplace may provide identifying data associated with the NFT to be purchased (e.g., block value information, information associated with the artifact, information associated with the copyright, a copyright registration number, a certificate of ownership registration number, etc.), a wallet ID and/or obtain a transaction approval by receiving a wallet ID, a transaction amount, a product description, line items, purchase order (PO) number(s), and/or invoice number(s). Once the registry system receives the information and the request to verify the wallet ID, the registry system may query the wallet ID registry to determine that the wallet to be used in the transaction is a legitimate and/or otherwise authentic wallet based on the wallet ID having previously been registered with the registry system.

At block 212, the process 200 may include the registry system sending an approval request to the electronic device 102 and at block 214, the process may include the electronic device 102 receiving the approval request. For example, the user associated with the wallet and/or the wallet ID may be sent a notification (e.g., via a text or mobile application) of the transaction and/or a request by the registry to approve the transaction. In this case the user may approve or deny the request.

At block 216, the process 200 may include the electronic device 102 sending a transaction approval to the registry system 104 and at block 218, the process may include the registry system 104 receiving the approval request.

At block 220, the process 200 may include the registry system sending a verification status to the third-party marketplace system 124 and at block 222, the process may include the third-party marketplace system 124 receiving the verification status. For example, once the wallet ID has been verified by the registry system and/or the registry system receives approval from the user, the registry system may send an indication to the third-party marketplace and/or a purchaser indicating a verification of the legitimacy of the wallet ID and/or the wallet to be used in the transaction.

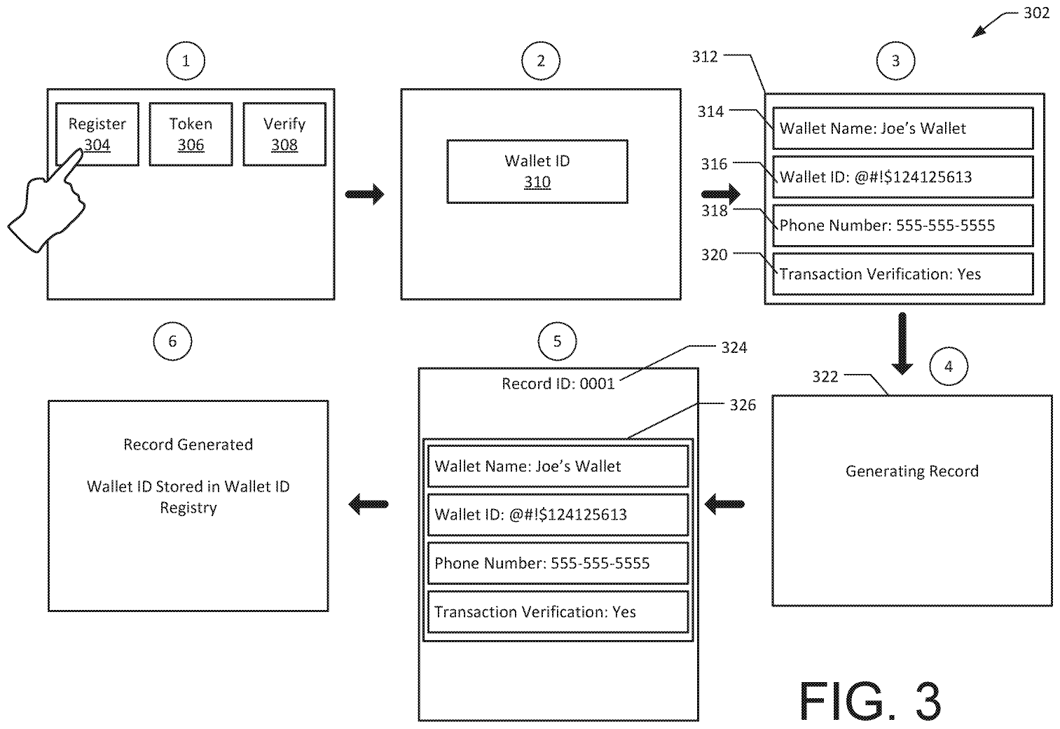

FIG. 3 illustrates an example user interface 302 displaying wallet information registration functionality in accordance with a registration and verification system. The user interface 302 may be displayed on a display of an electronic device, such as the electronic device 102 as described with respect to FIG. 1. The user interface 302 may be the same as or similar to the user interface(s) 122 as described with respect to FIG. 1. FIG. 3 illustrates a progression, from left to right and top to bottom, of information displayed on and/or interactions with the user interface 302.

For example, the user interface 302, at step 1, may include a first selectable portion 304 indicating an option to register wallet information and/or user information with a wallet ID registry. The user interface 302 may also include a second selectable portion 306 indicating an option to generate a token to be associated with a user and/or a wallet, and/or a third selectable portion 308 indicating an option to verify that a wallet ID has been registered in association with the wallet ID registry. To illustrate the use and functionality of the user interface 302, a user may provide input indicating selection of the first selectable portion 304.

Selection of the first selectable portion 304 may cause the user interface 302 to display, at step 2, a fourth selectable portion 310 indicating an option to identify a wallet ID to be registered with the wallet ID registry. Identification of the wallet ID may include input such as a naming indicator for the wallet and/or selection of a wallet from a database of an electronic device displaying the user interface 302, for example. The wallet may include data that represents or is used to describe the wallet, such as the wallet ID and/or a wallet address.

At step 3, the user interface 302 may include a record generation page 312 that presents a wallet name 314, a wallet ID 316 associated with the wallet, a phone number 318 associated with the user and/or wallet, and/or an indication 320 if the user has agreed to receiving transaction verification notifications. The record generation page 312 may be presented in response to the registry system receiving the request to register the wallet information and/or after the registry system verifies an authenticity of the entity making the request (e.g., via credit check, an employment verification, a background check, social security check, DUNS listing, etc.).

At step 4, the user interface 302 may include an indication 322 that the new record associated with the wallet information is being submitted the wallet ID registry to be stored. In some cases, registering the wallet information with the wallet ID registry may also include registering the wallet information with a blockchain. For example, the text may state that the record is being generated and while this text is being displayed, a communications component may generate request data indicating a request to register the wallet information with the blockchain. The request data may be sent to the remote system associated with the blockchain along with, for example, the wallet information. The remote system may receive the request data and the wallet information and may register wallet information with a block of the blockchain. The remote system may generate a token representing the block in the blockchain and/or the remote system may generate a time value indicating a time and/or day that the wallet information was registered with the blockchain. The remote system may send the token, the time value, and/or other information (such as a block number, for example) to the remote system associated with the wallet ID registry.

At step 5, the user interface 302 may display a record indicating that the wallet information has been registered with the wallet ID registry. The record may include a record identifier 324 and/or record details 326. The record details 324 may include numbers and/or letters that identify the record with respect to the wallet ID registry. The record details 326 may include the wallet name, the wallet ID, the phone number associated with the user, and/or the transaction verification indication.

At step 6, the user interface 302 may display a text indicating that the wallet information has been registered with the wallet ID registry.

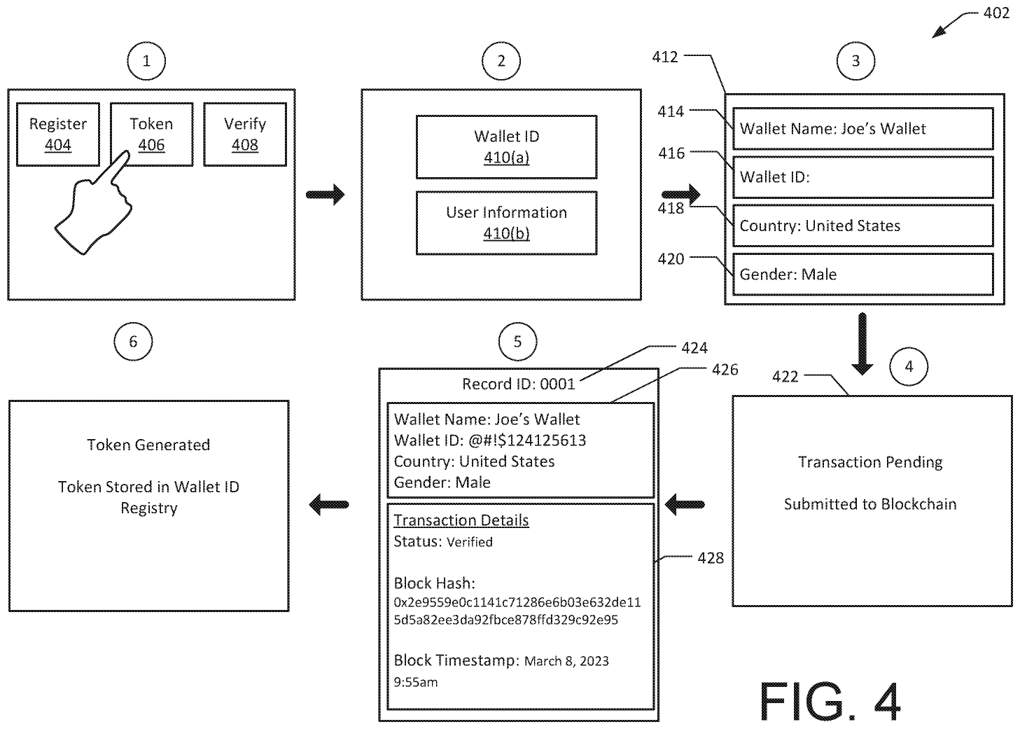

FIG. 4 illustrates an example user interface 402 displaying token generation functionality in accordance with a registration and verification system. The user interface 402 may be displayed on a display of an electronic device, such as the electronic device 102 as described with respect to FIG. 1. The user interface 402 may be the same as or similar to the user interface(s) 122 as described with respect to FIG. 1. FIG. 4 illustrates a progression, from left to right and top to bottom, of information displayed on and/or interactions with the user interface 402.

For example, the user interface 402, at step 1, may include a first selectable portion 404 indicating an option to register wallet information and/or user information with a wallet ID registry. The user interface 402 may also include a second selectable portion 406 indicating an option to generate a token to be associated with a user and/or a wallet, and/or a third selectable portion 408 indicating an option to verify that a wallet ID has been registered in association with the wallet ID registry. To illustrate the use and functionality of the user interface 402, a user may provide input indicating selection of the second selectable portion 406.

Selection of the second selectable portion 406 may cause the user interface 402 to display, at step 2, a fourth selectable portion 410(a) indicating an option to identify a wallet ID and a fifth selectable portion 410(b) indicating an option to identify user information to be registered with the wallet ID registry and/or used to generate a token associated with the user and/or the wallet. Identification of the wallet ID may include input such as a naming indicator for the wallet and/or selection of a wallet from a database of an electronic device displaying the user interface 402, for example. The wallet may include data that represents or is used to describe the wallet, such as the wallet ID and/or a wallet address. In some cases, user information may include an age of the user, tax information associated with the user, employment information associated with the user, residence information associated with the user, and/or citizenship information associated with the user, etc.

At step 3, the user interface 402 may include a token generation page 412 that presents a wallet name 414, a wallet ID 416 associated with the wallet, a country identifier 418 associated with the user and/or wallet, and/or a gender identifier 420 associated with the wallet and/or user. The record generation page 412 may be presented in response to the registry system receiving the request to register the wallet information and/or the user information and/or after the registry system verifies an authenticity of the entity making the request (e.g., via credit check, an employment verification, a background check, social security check, DUNS listing, etc.).

At step 4, the user interface 402 may include an indication 422 that the wallet information and/or the user information is being submitted a blockchain. For example, the text may state that the transaction is pending while the information is being submitted to the blockchain and while this text is being displayed, a communications component may generate request data indicating a request to register the wallet information with the blockchain in order to generate a token. The request data may be sent to the remote system associated with the blockchain along with, for example, the wallet information and/or the user information. The remote system may receive the request data and the wallet information and/or the user information and may register wallet information and/or the user information with a block of the blockchain. The remote system may generate a token representing the block in the blockchain and/or the remote system may generate a time value indicating a time and/or day that the wallet information and/or the user information was registered with the blockchain. The remote system may send the token, the time value, and/or other information (such as a block number, for example) to the remote system associated with the wallet ID registry.

At step 5, the user interface 402 may display a record indicating that the token has been generated. The record may include a record identifier 424 and/or record details 426. The record details 424 may include numbers and/or letters that identify the record with respect to the wallet ID registry. The record details 426 may include the wallet name, the wallet ID, the country associated with the user, and/or the gender associated with the user and/or wallet. The record may also indicate transaction details 428 including a status of the registration with the wallet ID registry, a block number associated with the block at which the token is registered with the blockchain, and/or the block timestamp.

At step 6, the user interface 402 may display a text indicating that token has been generated and has been registered with the wallet ID registry and/or provided to the user to be stored in the wallet associated with the user. Once generated the token can be used for identity verification in response to receiving the input data and/or the request data. For example, a wallet holder may request generation and/or certification of such identity tokens by the registry system, which will in turn be assigned and/or issued to the wallet ID such that the user may demonstrate that certain requirements are met in the consumption of a given service. For example, the registry system may provide an allocation of a token (e.g., and NFT type token) that represent an identity parameter (e.g. “is over 21”). In some cases, the registry system may initiate a smart contract transaction effectively minting a request of a token with the wallet ID to which the identity parameter is intended to be assigned. Once the token is assigned to the wallet, registry system may act as a verification and/or a certifying authority. For example a service provider that desires to verify an age of a wallet holder, may query the registry system with a wallet ID. In some cases, the registry system may return the appropriate response if such a token exists for the wallet in question. In some examples, the tokens may be configured to be non-transferrable, as they will be valid only for the initial wallet to which it is assigned.

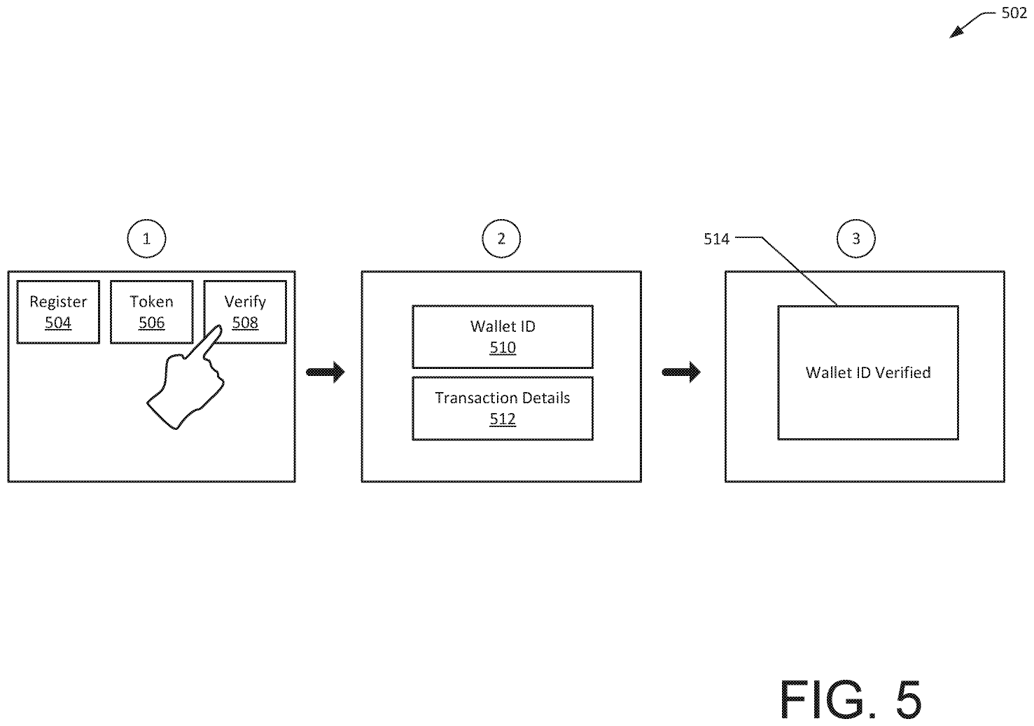

FIG. 5 illustrates an example user interface 502 displaying wallet information verification functionality in accordance with a registration and verification system. The user interface 502 may be displayed on a display of an electronic device of a third-party marketplace system, such as the third-party marketplace system 124 as described with respect to FIG. 1. The user interface 502 may be the same as or similar to the user interface(s) 160 as described with respect to FIG. 1. FIG. 5 illustrates a progression, from left to right and top to bottom, of information displayed on and/or interactions with the user interface 502.

For example, the user interface 502, at step 1, may include a first selectable portion 504 indicating an option to register wallet information and/or user information with a wallet ID registry. The user interface 502 may also include a second selectable portion 506 indicating an option to generate a token to be associated with a user and/or a wallet, and/or a third selectable portion 508 indicating an option to verify that a wallet ID has been registered in association with the wallet ID registry. To illustrate the use and functionality of the user interface 502, a user may provide input indicating selection of the third selectable portion 508.

Selection of the third selectable portion 508 may cause the user interface 502 to display, at step 2, a fourth selectable portion 510 indicating an option to identify a wallet ID to be verified with the registry system and/or transaction details 512 associated with a transaction between the third-party marketplace system and a user associated with a wallet associated with the wallet ID. In some cases, the transaction details 512 may include a transaction amount, a product description, line items, purchase order (PO) number(s), and/or invoice number(s). For example, an entity that created an artifact and/or is associated (e.g., assigned) with a copyright of an artifact may offer for sale a number of NFTs associated with the copyright and/or artifact on a third-party marketplace. In some cases, the third-party marketplace may send a request to the registry system that a particular wallet ID associated with a wallet of a user attempting to make a purchase is authentic and/or is otherwise legitimate. In this case, the third-party marketplace may provide identifying data associated with the NFT to be purchased (e.g., block value information, information associated with the artifact, information associated with the copyright, a copyright registration number, a certificate of ownership registration number, etc.), a wallet ID and/or obtain a transaction approval by receiving a wallet ID, a transaction amount, a product description, line items, purchase order (PO) number(s), and/or invoice number(s). Once the registry system receives the information and the request to verify the wallet ID, the registry system may query the wallet ID registry to determine that the wallet to be used in the transaction is a legitimate and/or otherwise authentic wallet based on the wallet ID having previously been registered with the registry system. In some examples, the user associated with the wallet and/or the wallet ID may be sent a notification (e.g., via a text or mobile application) of the transaction and/or a request by the registry to approve the transaction. In this case the user may approve or deny the request. In this way, the registry system provides a second factor of authentication or protection should a wallet holders account be compromised.

At step 3, the user interface 502 may include a verification status page 514 indicating a verification status of the wallet ID by the registry system. In this example, the user interface 502 indicates that the registry system has verified the wallet ID.

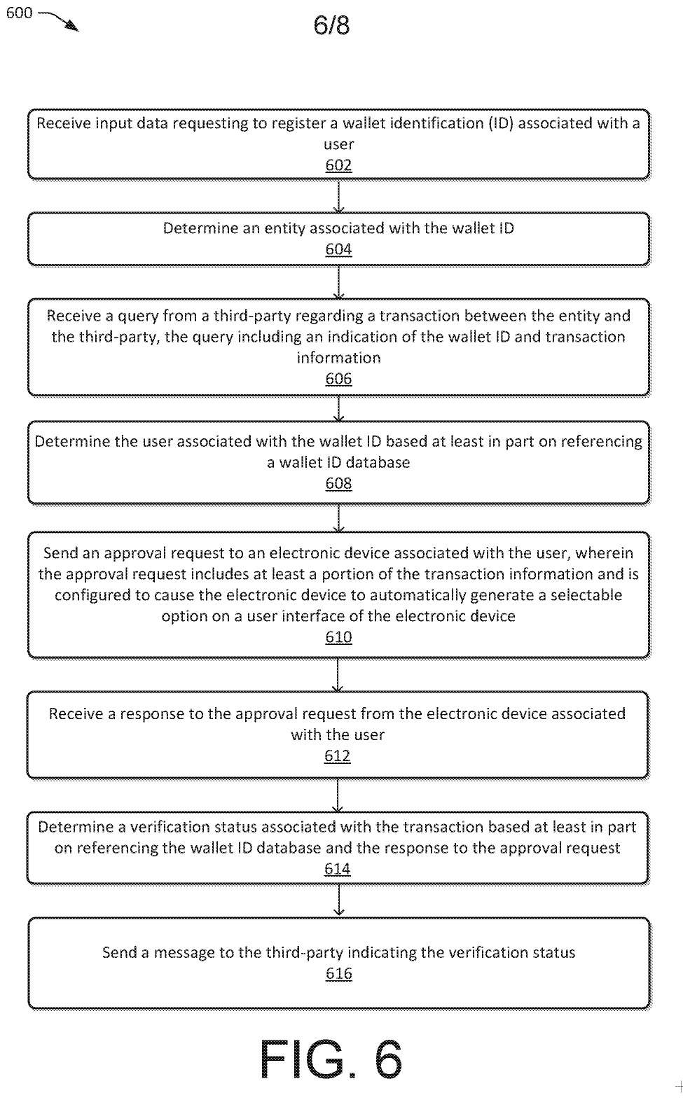

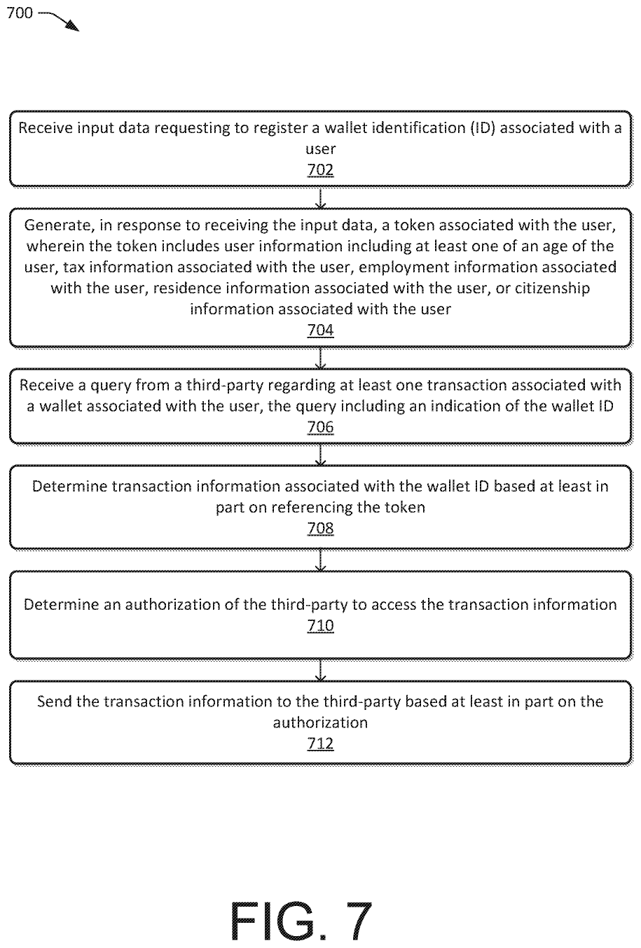

FIGS. 6 and 7 illustrate processes for wallet information registration and verification. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-5, although the processes may be implemented in a wide variety of other environments, architectures and systems.

FIG. 6 illustrates a flow diagram of an example process for wallet information registration and verification in accordance with a registration and verification system. The order in which the operations or steps are described is not intended to be construed as a limitation, and any number of the described operations may be combined in any order and/or in parallel to implement process 600.

At block 602, the process 600 may include the registry system receiving input data requesting to register a wallet identification (ID) associated with a user. For example a client-side device and/or system, herein described as an electronic device, may include an application that enables a user of the device and/or system to provide input data to the device. The input data may include a request to register a wallet ID with the system and may indicate information associated with a wallet, such as the wallet ID, as well as information associated with the user, such as an age of the user, tax information associated with the user, employment information associated with the user, residence information associated with the user, or citizenship information associated with the user, etc.

At block 604, the process 600 may include the registry system determining an entity associated with the wallet ID. For example, prior to registering the wallet ID, the registry system may perform a review process on the entity making the request in order to verify and/or authenticate that the entity is credible. In some cases, the registry system may have access to data associated with the entity, such as, credit history, social security information, a DUNS listing, etc., and the registry system may access this information to authenticate the entity.

At block 606, the process 600 may include the registry system receiving a query from a third-party regarding a transaction between the entity and the third-party, the query including an indication of the wallet ID and transaction information. For example, the registry system may receive a request to verify a wallet ID and/or obtain a transaction approval by receiving a wallet ID, a transaction amount, a product description, line items, purchase order (PO) number(s), and/or invoice number(s). For example, an entity that created an artifact and/or is associated (e.g., assigned) with a copyright of an artifact may offer for sale a number of NFTs associated with the copyright and/or artifact on a third-party marketplace. In some cases, the third-party marketplace may send a request to the registry system that a particular wallet ID associated with a wallet of a user attempting to make a purchase is authentic and/or is otherwise legitimate. In this case, the third-party marketplace may provide identifying data associated with the NFT to be purchased (e.g., block value information, information associated with the artifact, information associated with the copyright, a copyright registration number, a certificate of ownership registration number, etc.), a wallet ID and/or obtain a transaction approval by receiving a wallet ID, a transaction amount, a product description, line items, purchase order (PO) number(s), and/or invoice number(s). Once the registry system receives the information and the request to verify the wallet ID, the registry system may query the wallet ID registry to determine that the wallet to be used in the transaction is a legitimate and/or otherwise authentic wallet based on the wallet ID having previously been registered with the registry system.

At block 608, the process 600 may include the registry determining the user associated with the wallet ID based at least in part on referencing a wallet ID database. For example, the registry system may generate a record in the wallet ID registry. The record may include information associated with the wallet, the wallet ID, the user, and/or the token. For example, the record may associate the information together such that the wallet ID is stored in association with an age of the user, tax information associated with the user, employment information associated with the user, residence information associated with the user, or citizenship information associated with the user, a block number associated with the block of the blockchain that the token is registered with, a token ID, the time value, and/or one or more other types of data associated with the wallet and/or user, such as valuation, insurance policy information, versioning information, etc. The registry system, in examples, may generate confirmation data indicating that the record has been generated, and the confirmation data may be sent to the client-side device and/or system for display, e.g., via a user interface, or otherwise made available for programmatic consumption by an outside system.

At block 610, the process 600 may include the registry system sending an approval request to an electronic device associated with the user, wherein the approval request includes at least a portion of the transaction information and is configured to cause the electronic device to automatically generate a selectable option on a user interface of the electronic device. For example, the user associated with the wallet and/or the wallet ID may be sent a notification (e.g., via a text or mobile application) of the transaction and/or a request by the registry to approve the transaction. The request may cause a selectable option to approve or disapprove the transaction via a user interface of the electronic device associated with the user. In some cases, the selectable option may be presented automatically on the user interface. For instance, the selectable option may be presented to the user as a notification such that the electronic device is woken up from a sleep mode and/or the notification is presented to the user on top of an existing application being accessed by the user at the time the approval request was received. In this case the user may approve or deny the request. In this way, the registry system provides a second factor of authentication or protection should a wallet holders account be compromised.

At block 612, the process 600 may include the registry system receiving a response to the approval request from the electronic device associated with the user.

At block 614, the process 600 may include the registry system determining a verification status associated with the transaction based at least in part on referencing the wallet ID database and the response to the approval request. For example, once the wallet ID has been verified by the registry system and/or the registry system receives approval from the user, the registry system may send an indication to the third-party marketplace and/or a purchaser indicating a verification of the legitimacy of the wallet ID and/or the wallet to be used in the transaction.

At block 616, the process 600 may include the registry system sending a message to the third-party indicating the verification status.

Additionally, and/or alternatively, in some examples the process 600 may include the wallet ID database being associated with at least one insurer associated with at least one of the user or a wallet associated with the user.

Additionally, and/or alternatively, in some examples the process 600 may include the input data being received via an application associated with at least one insurer associated with at least one of the user or a wallet associated with the user.

Additionally, and/or alternatively, in some examples the process 600 may include wallet ID identifying a wallet associated with the user and the transaction.

Additionally, and/or alternatively, in some examples the process 600 may include the wallet comprising a custodial wallet associated with a certified custodian, the input data being received via an insurer providing insurance for multiple custodial wallets associated with the certified custodian.

Additionally, and/or alternatively, in some examples the process 600 may include the verification status indicating that the user is authorized to use a wallet associated with the wallet ID and the message includes an approval identifier.

Additionally, and/or alternatively, in some examples the process 600 may include referencing the wallet ID database including accessing the token.

Additionally, and/or alternatively, in some examples the process 600 may include the transaction information including at least one of a transaction amount, a product description, at least one line item, a purchase order number, or an invoice number.

FIG. 7 illustrates a flow diagram of an example process for artifact and/or master NFT registration and verification in accordance with an artifact and/or master NFT registration and verification system. The order in which the operations or steps are described is not intended to be construed as a limitation, and any number of the described operations may be combined in any order and/or in parallel to implement process 700.

At block 702, the process 700 may include the registry system receiving input data requesting to register a wallet identification (ID) associated with a user. For example a client-side device and/or system, herein described as an electronic device, may include an application that enables a user of the device and/or system to provide input data to the device. The input data may include a request to register a wallet ID with the system and may indicate information associated with a wallet, such as the wallet ID, as well as information associated with the user, such as an age of the user, tax information associated with the user, employment information associated with the user, residence information associated with the user, or citizenship information associated with the user, etc.

At block 704, the process 700 may include the registry system generating, in response to receiving the input data, a token associated with the user, wherein the token includes user information including at least one of an age of the user, tax information associated with the user, employment information associated with the user, residence information associated with the user, or citizenship information associated with the user. For example, the registry system may receive the input data and/or the request data and may store the wallet ID and the information associated with the user. In some examples, the registry system may generate a token that can be used for identity verification in response to receiving the input data and/or the request data. For example, a wallet holder may request generation and/or certification of such identity tokens by the registry system, which will in turn be assigned and/or issued to the wallet ID such that the user may demonstrate that certain requirements are met in the consumption of a given service. For example, the registry system may provide an allocation of a token (e.g., and NFT type token) that represent an identity parameter (e.g. “is over 21”). In some cases, the registry system may initiate a smart contract transaction effectively minting a request of a token with the wallet ID to which the identity parameter is intended to be assigned. Once the token is assigned to the wallet, registry system may act as a verification and/or a certifying authority. For example a service provider that desires to verify an age of a wallet holder, may query the registry system with a wallet ID. In some cases, the registry system may return the appropriate response if such a token exists for the wallet in question. In some examples, the tokens may be configured to be non-transferrable, as they will be valid only for the initial wallet to which it is assigned.

At block 706, the process 700 may include the registry system receiving a query from a third-party regarding at least one transaction associated with a wallet associated with the user, the query including an indication of the wallet ID. For example, the registry system may receive a request from verified government agencies for the purpose of auditing transactions maintained within the registry system. For example, the register system may receive a request from a governmental agency which may include an indication of legal authority to identify an individual associated with a given wallet address and/or a wallet ID. In some cases, the query may be received from a third-party marketplace involved in a transaction with the user and the third-party marketplace may be sending the query to the registry system in order to verify that the wallet ID and/or the user are authentic. In some examples, the query may be a blind query (e.g., a blind SQL injection) such that the third-party marketplace is not able to access any personal identifiable information associated with the user but, instead, only receives affirmative and/or disaffirmation responses. In this case, the registry system enables government agencies and/or entities to perform auditing while ensuring that decentralized environments (e.g., Web3) are able to meet Anti-Money Laundering (AML) requirements and/or Know Your Customer (KYC) requirements without gathering personally identifiable information (PII) directly from end users.

At block 708, the process 700 may include the registry determining transaction information associated with the wallet ID based at least in part on referencing the token.

At block 710, the process 600 may include the registry system determining an authorization of the third-party to access the transaction information. For example, the register system may receive a request from a governmental agency which may include an indication of legal authority to identify an individual associated with a given wallet address and/or a wallet ID.

At block 712, the process 600 may include the registry system sending the transaction information to the third-party based at least in part on the authorization.

Additionally, and/or alternatively, in some examples the process 700 may include the third-party comprising a virtual platform and the artifact comprising a virtual item to be rendered in the virtual platform.

Additionally, and/or alternatively, in some examples the process 700 may include the third-party comprising a governmental agency

Additionally, and/or alternatively, in some examples the process 700 may include sending the token to an electronic device associated with the user.

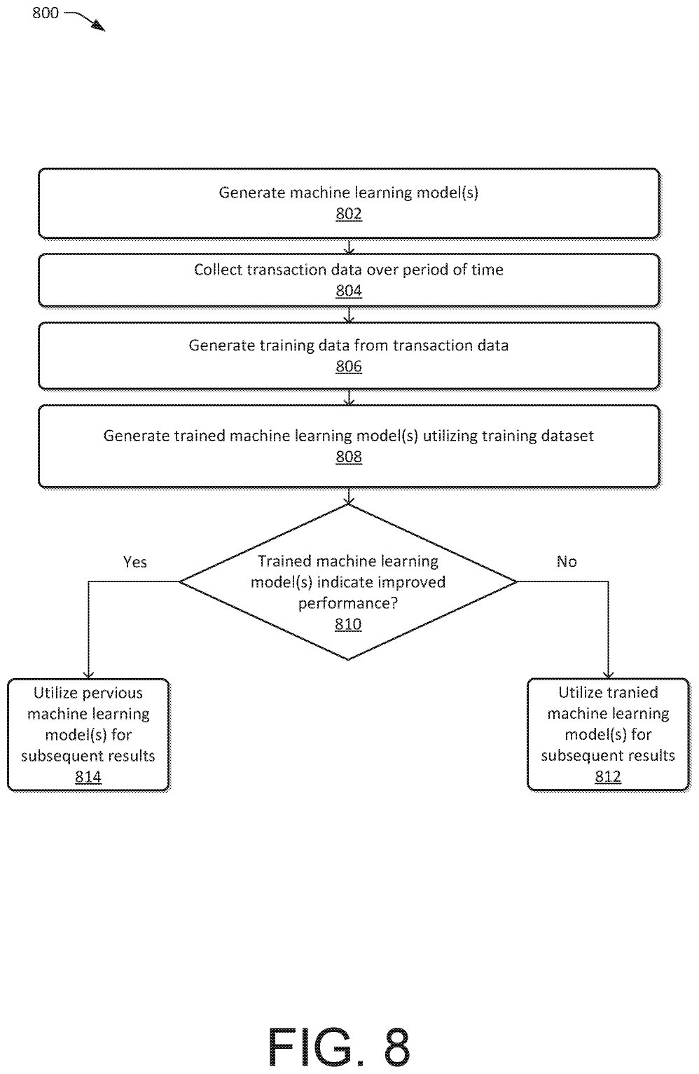

FIG. 8 illustrates a flow diagram of an example process 800 for training and utilizing one or more machine learning models to perform operations as described herein. The order in which the operations or steps are described is not intended to be construed as a limitation, and any number of the described operations may be combined in any order and/or in parallel to implement process 800.

At block 802, the process 800 may include generating one or more machine learning models. For example, the machine learning models may utilize predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases, and may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter predictive modelling may be performed to generate accurate predictive models.

At block 804, the process 800 may include collecting transaction data over a period of time. The transaction data may include information associated with payment card transactions, reward amounts, user preferences, settlement amounts, reward amounts in a reward queue, pre-funded wallet metrics, cryptocurrency exchange occurrence and/or rates, metrics on automatic deposits into the lending platform, metrics on automatic deposits into user wallets, cryptocurrency type selections, earning amounts, and/or any other data described herein.

At block 806, the process 800 may include generating a training dataset from the transaction data. Generation of the training dataset may include formatting the transaction data into input vectors for the machine learning model to intake, as well as associating the various data with the transaction outcomes.

At block 808, the process 800 may include generating one or more trained machine learning models utilizing the training dataset. Generation of the trained machine learning models may include updating parameters and/or weightings and/or thresholds utilized by the models to generate recommendations and/or to perform adjustments of earning amounts as described herein. It should be understood that the trained machine learning models may be configured to determine factors for recommendations associated with adjusted earning amounts, cryptocurrency types, whether to deposit rewards into a lending platform, products to purchase, payment instruments to use, etc.

At block 810, the process 800 may include determining whether the trained machine learning models indicate improved performance metrics. For example, a testing group may be generated where the outcomes of the recommendations and/or adjustments are known but not to the trained machine learning models. The trained machine learning models may generate the recommendations and/or perform the adjustment operations, which may be compared to the known results to determine whether the results of the trained machine learning model produce a superior result than the results of the machine learning model prior to training.

In examples where the trained machine learning models indicate improved performance metrics, the process 800 may include, at block 812, utilizing the trained machine learning models for generating subsequent results.

In examples where the trained machine learning models do not indicate improved performance metrics, the process 800 may include, at block 814, utilizing the previous iteration of the machine learning models for generating subsequent results. It should be understood that while several examples of how machine learning models may be utilized are described in FIG. 6, the machine learning models may be utilized to perform any of the processes described herein and/or to make any of the determinations described herein.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system comprising:
one or more processors; and
non-transitory computer-readable media storing computer-executable instructions that, when executed by the one or more processors, cause the one or more processors to perform operations comprising:
receiving input data requesting to register a wallet identification (ID) associated with a user;
receiving a blind query from a third-party regarding a transaction between the user and the third-party, the blind query including an indication of the wallet ID and transaction information associated with the transaction;
determining the user associated with the wallet ID based at least in part on referencing a wallet ID database;
sending an approval request to an electronic device associated with the user, wherein the approval request includes at least a portion of the transaction information associated with the transaction and is configured to cause the electronic device to automatically generate a selectable option on a user interface of the electronic device;
receiving a response to the approval request from the electronic device associated with the user;
determining a verification status associated with the transaction based at least in part on referencing the wallet ID database and the response to the approval request; and
sending a message to the third-party indicating the verification status.

2. The system of claim 1, wherein the wallet ID database is associated with at least one insurer associated with at least one of the user or a wallet associated with the user.

3. The system of claim 1, wherein the input data is received via an application associated with at least one insurer associated with at least one of the user or a wallet associated with the user.

4. The system of claim 1, wherein wallet ID identifies a wallet associated with the user and the transaction.

5. The system of claim 4, wherein the wallet comprises a custodial wallet associated with a certified custodian, the input data being received via an insurer providing insurance for multiple custodial wallets associated with the certified custodian.

6. The system of claim 1, wherein the verification status indicates that the user is authorized to use a wallet associated with the wallet ID and the message includes an approval identifier.

7. The system of claim 1, further comprising generating, in response to receiving the input data, a token associated with the user, wherein the token includes user information including at least one of an age of the user, tax information associated with the user, employment information associated with the user, residence information associated with the user, or citizenship information associated with the user.

8. The system of claim 7, wherein the referencing the wallet ID database includes accessing the token.

9. The system of claim 1, wherein the transaction information associated with the transaction includes at least one of a transaction amount, a product description, at least one line item, a purchase order number, or an invoice number.

10. A method, comprising:
receiving input data requesting to register a wallet identification (ID) associated with a user;
receiving a blind query from a third-party regarding a transaction between the user and the third-party, the blind query including an indication of the wallet ID and transaction information associated with the transaction;
determining the user associated with the wallet ID based at least in part on referencing a wallet ID database;
determining a verification status associated with the transaction based at least in part on referencing the wallet ID database; and
sending a message to the third-party indicating the verification status.

11. The method of claim 10, wherein the wallet ID database is associated with at least one insurer associated with at least one of the user or a wallet associated with the user.

12. The method of claim 10, wherein the input data is received via an application associated with at least one insurer associated with at least one of the user or a wallet associated with the user.

13. The method of claim 10, further comprising:
sending an approval request to an electronic device associated with the user, wherein the approval request includes at least a portion of the transaction information associated with the transaction and is configured to cause the electronic device to automatically generate a selectable option on a user interface of the electronic device;
receiving a response to the approval request from the electronic device associated with the user; and
determining the verification status associated with the transaction based at least in part on receiving the response to the approval request from the electronic device associated with the user.

14. The method of claim 13, wherein the wallet ID identifies a wallet associated with the user and the wallet comprises a custodial wallet associated with a certified custodian, the input data being received via an insurer providing insurance for multiple custodial wallets associated with the certified custodian.

15. The method of claim 10, wherein the verification status indicates that the user is authorized to use a wallet associated with the wallet ID and the message includes an approval identifier.

16. The method of claim 10, further comprising generating, in response to receiving the input data, a token associated with the user, wherein the token includes user information including at least one of an age of the user, tax information associated with the user, employment information associated with the user, residence information associated with the user, or citizenship information associated with the user.

17. The method of claim 16, wherein referencing the wallet ID database includes accessing the token.

18. A method, comprising:
receiving input data requesting to register a wallet identification (ID) associated with a user;
generating, in response to receiving the input data, a token associated with the user, wherein the token includes user information including at least one of an age of the user, tax information associated with the user, employment information associated with the user, residence information associated with the user, or citizenship information associated with the user;
receiving a blind query from a third-party regarding at least one transaction associated with a wallet associated with the user, the blind query including an indication of the wallet ID;
determining transaction information associated with the wallet ID based at least in part on referencing the token;
determining an authorization of the third-party to access the transaction information associated with the wallet ID; and
sending the transaction information associated with the wallet ID to the third-party based at least in part on the authorization.

19. The method of claim 18, wherein the third-party comprise a governmental agency.

20. The method of claim 18, further comprising sending the token to an electronic device associated with the user.
